(19) United States
(12) Patent Application Publication
(10) Pub. No.: US 2025/0192811 A1
(43) Pub. Date: Jun. 12, 2025

(54) RADIO-FREQUENCY MODULE

(71) Applicant: Murata Manufacturing Co., Ltd., Kyoto (JP)

(72) Inventor: Naofumi TAKEZONO, Kyoto (JP)

(21) Appl. No.: 18/975,221

(22) Filed: Dec. 10, 2024

(30) Foreign Application Priority Data
Dec. 11, 2023 (JP) 2023-208750

(51) Int. Cl. H04B 1/04; H04B 1/00

(52) U.S. Cl. CPC H04B 1/0483; H04B 1/006

(57) ABSTRACT

A radio-frequency module includes a first external connection terminal connected to a first external power supply, a second external connection terminal connected to a second external power supply, a first switch connected to the first external connection terminal and a first connection point, a second switch connected to the second external connection terminal and the first connection point, a third external connection terminal connected to the first connection point, and a third switch connected to a second connection point between the second switch and the third external connection terminal. Another end of the third switch is connected to a first capacitor. The second connection point is connected a second capacitor. Another end of the first capacitor and another end of the second capacitor are connected to an inductor. Another end of the inductor is connected to a reference potential.

### CROSS REFERENCE TO RELATED APPLICATION

This application claims priority from Japanese Patent Application No. 2023-208750 filed on Dec. 11, 2023. The content of this application is incorporated herein by reference in its entirety.

### BACKGROUND ART

The present disclosure relates to a radio-frequency module.

Japanese Unexamined Patent Application Publication No. 2009-124357 discloses a switching circuit configuration in which two inputs and one output are provided to switch between two power supplies.

### BRIEF SUMMARY

In recent years, in communication devices, a front-end module for an ultra-high band (UHB) has been incorporated in addition to front-end modules for a low band (LB) and a middle-high band (MHB). Although an example is given in which the low band refers to Long Term Evolution (LTE) bands B8 and B28 and in which its frequency band is not more than 1 GHZ, the present disclosure is not limited to this. Although an example is given in which the middle- high band refers to LTE bands B39 and B41 and in which its frequency band is from about 1.8 GHz to 2.7 GHZ, the present disclosure is not limited to this. Although an example is given in which the ultra-high band refers to 5th Generation New Radio (5G NR) bands n77, n78, and n79 and in which its frequency band is from about 3.3 GHZ to 5 GHZ, the present disclosure is not limited to this.

As described above, in a communication device, a plurality of front-end modules (FEMs) corresponding to a respective plurality of bands are incorporated.

Additionally, to achieve reductions in the size and cost of the communication device, a common power supply is provided for the plurality of front-end modules.

In providing a common power supply for the plurality of front-end modules, however, there is concern that a harmonic output from a transmission system in one front-end module passes through a power-supply line to reduce the reception sensitivity of another front-end module.

To overcome this, in the related art, a T-type switch is used to provide isolation between a plurality of front-end modules. However, the T-type switch includes a total of three switches: two switches connected in series, and one switch connected in shunt. Hence, the size of a semiconductor device in which the T-type switch is formed is increased, causing an increase in cost. This also increases the size of a radio-frequency module, causing an increase in cost.

The present disclosure has been made in view of the above and aims to achieve reductions in the size and cost of a radio-frequency module.

A radio-frequency module according to an aspect of the present disclosure includes a first external connection terminal electrically connected to a first external power supply, a second external connection terminal electrically connected to a second external power supply, a first switch having one end electrically connected to the first external connection terminal and another end electrically connected to a first connection point, a second switch having one end electrically connected to the second external connection terminal and another end electrically connected to the first connection point, a third external connection terminal electrically connected to the first connection point, and a third switch having one end electrically connected to a second connection point between the other end of the second switch and the third external connection terminal. Another end of the third switch is electrically connected to one end of a first capacitor. The second connection point is electrically connected to one end of a second capacitor. Another end of the first capacitor and another end of the second capacitor are electrically connected to one end of an inductor. Another end of the inductor is electrically connected to a reference potential.

The present disclosure enables reductions in the size and cost of the radio-frequency module.

### BRIEF DESCRIPTION OF THE DRAWINGS

FIG. 1 is a diagram illustrating an example of a configuration of a communication device including a plurality of front-end modules;

FIG. 2 is a diagram illustrating a configuration of a switch circuit according to a comparative example;

FIG. 3 is a diagram illustrating a configuration of a switch circuit according to a first embodiment;

FIG. 4 is a graph illustrating circuit simulation results of the switch circuit according to the first embodiment;

FIG. 5 is a graph illustrating circuit simulation results of the switch circuit according to the first embodiment;

FIG. 6 is a diagram illustrating a configuration of a switch circuit according to a second embodiment;

FIG. 7 is a diagram illustrating a configuration of a switch circuit according to a third embodiment; and

FIG. 8 is a diagram illustrating a configuration of a switch circuit according to a fourth embodiment.

### DETAILED DESCRIPTION

Embodiments of the present disclosure will be described in detail below with reference to the drawings. Note that the present disclosure is not to be limited by these embodiments. Each embodiment is merely an example, and it goes without necessarily saying that configurations described in different embodiments can be partially replaced or combined. In second and subsequent embodiments, a description of things in common with a first embodiment is omitted, and only respects in which the second and subsequent embodiments differ from the first embodiment will be described. In particular, similar function effects achieved by similar configurations are not repeatedly described in each embodiment.

### First Embodiment

### Example of Configuration of Communication Device Including a Plurality of Front-End Modules

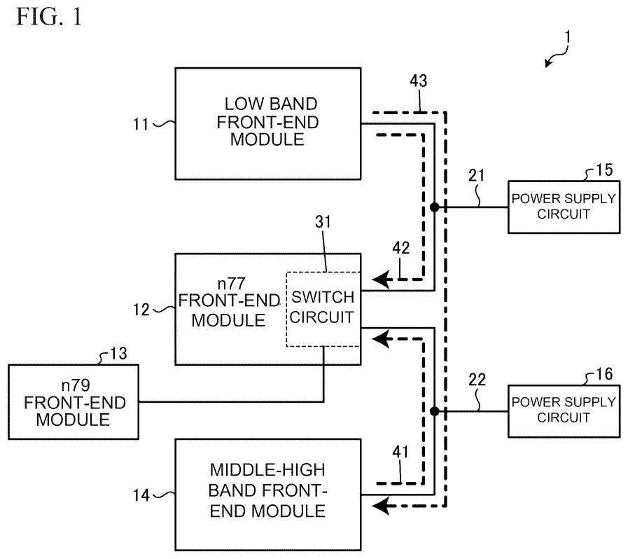

FIG. 1 is a diagram illustrating an example of a configuration of a communication device including a plurality of front-end modules.

A communication device 1 includes a low band front-end module 11, an n77 front-end module 12, an n79 front-end module 13, a middle-high band front-end module 14, a power supply circuit 15, and a power supply circuit 16.

The n77 front-end module 12 corresponds to an example of “radio-frequency module” in the present disclosure.

Although an example is given in which a low band refers to Long Term Evolution (LTE) bands B8 and B28 and in which its frequency band is not more than 1 GHZ, the present disclosure is not limited to this. Although an example is given in which a middle-high band refers to LTE bands B39 and B41 and in which its frequency band is from about 1.8 GHz to 2.7 GHZ, the present disclosure is not limited to this.

In the communication device 1, the power supply circuit 15 supplies power to the low band front-end module 11 via a line 21. Furthermore, the power supply circuit 15 supplies power to the n77 front-end module 12 via the line 21.

The n77 front-end module 12 includes a switch circuit 31. The power supply circuit 15 supplies power to the n79 front-end module 13 via the line 21 and the switch circuit 31.

The power supply circuit 16 supplies power to the n77 front-end module 12 via a line 22. Furthermore, the power supply circuit 16 supplies power to the n79 front-end module 13 via the line 22 and the switch circuit 31. Furthermore, the power supply circuit 16 supplies power to the middle-high band front-end module 14 via the line 22.

### First Operation of Communication Device

A case is examined where the n77 front-end module 12 and/or the n79 front-end module 13, and the middle-high band front-end module 14 simultaneously operate. In this case, the power supply circuit 15 supplies power to the n77 front-end module 12 and/or the n79 front-end module 13 via the line 21, and the power supply circuit 16 supplies power to the middle-high band front-end module 14 via the line 22.

At this time, as indicated by an arrow 41, a harmonic (a radio-frequency signal in a frequency band of an ultra-high band) of a middle-high band signal is transmitted from the middle-high band front-end module 14 to the n77 front-end module 12 and/or the n79 front-end module 13 via the line 22. This reduces the reception sensitivity of the n77 front-end module 12 and/or the n79 front-end module 13.

### Second Operation of Communication Device

A case is examined where the low band front-end module 11, and the n77 front-end module 12 and/or the n79 front-end module 13 simultaneously operate. In this case, the power supply circuit 15 supplies power to the low band front-end module 11 via the line 21, and the power supply circuit 16 supplies power to the n77 front-end module 12 and/or the n79 front-end module 13 via the line 22.

At this time, as indicated by an arrow 42, a harmonic (a radio-frequency signal in the frequency band of the ultra-high band) of a low band signal is transmitted from the low band front-end module 11 to the n77 front-end module 12 and/or the n79 front-end module 13 via the line 21. This reduces the reception sensitivity of the n77 front-end module 12 and/or the n79 front-end module 13.

### Third Operation of Communication Device

A case is examined where the low band front-end module 11 and the middle-high band front-end module 14 simultaneously operate. In this case, the power supply circuit 15 supplies power to the low band front-end module 11 via the line 21, and the power supply circuit 16 supplies power to the middle-high band front-end module 14 via the line 22.

At this time, as indicated by an arrow 43, a harmonic (a radio-frequency signal in the frequency band of the middle-high band) of a low band signal is transmitted from the low band front-end module 11 to the middle-high band front-end module 14 via the line 21, the switch circuit 31, and the line 22. This reduces the reception sensitivity of the middle-high band front-end module 14.

To keep such harmonics from being transmitted, the switch circuit 31 has to provide isolation between a plurality of front-end modules.

### Comparative Example

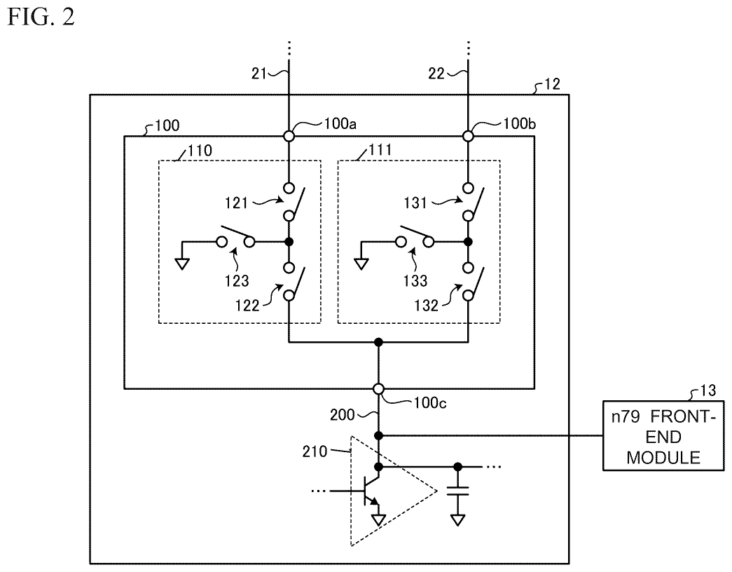

FIG. 2 is a diagram illustrating a configuration of a switch circuit according to a comparative example.

A switch circuit 100 includes terminals 100a to 100c. The terminal 100a is electrically connected to the line 21 (see FIG. 1). The terminal 100b is electrically connected to the line 22 (see FIG. 1). The terminal 100c is electrically connected to an internal circuit (for example, a power amplifier 210) of the n77 front-end module 12, and the n79 front-end module 13 via a line 200.

The switch circuit 100 includes a T-type switch 110 and a T-type switch 111. The T-type switch 110 includes switches 121 to 123. The T-type switch 111 includes switches 131 to 133.

One end of the switch 121 is electrically connected to the terminal 100a. The other end of the switch 121 is electrically connected to one end of the switch 122 and one end of the switch 123. The other end of the switch 122 is electrically connected to the terminal 100c. The other end of the switch 123 is electrically connected to a reference potential.

One end of the switch 131 is electrically connected to the terminal 100b. The other end of the switch 131 is electrically connected to one end of the switch 132 and one end of the switch 133. The other end of the switch 132 is electrically connected to the terminal 100c. The other end of the switch 133 is electrically connected to the reference potential.

### First Operation in Comparative Example

A case is examined where the n77 front-end module 12 and/or the n79 front-end module 13, and the middle-high band front-end module 14 (see FIG. 1) simultaneously operate. In this case, the power supply circuit 15 (see FIG. 1) supplies power to the n77 front-end module 12 and/or the n79 front-end module 13 via the line 21, and the power supply circuit 16 (see FIG. 1) supplies power to the middle-high band front-end module 14 via the line 22.

In this case, the switch 121 and the switch 122 enter an ON state. Furthermore, the switch 123 enters an OFF state. Thus, power output from the power supply circuit 15 is supplied to an internal element of the n77 front-end module 12, and/or the n79 front-end module 13 via the line 21, the switch 121, and the switch 122.

At this time, the switch 131 and the switch 132 enter an OFF state. Furthermore, the switch 133 enters an ON state. Incidentally, when the switch 131 is in the OFF state, the switch 131 can interrupt the supply of power from the power supply circuit 16 but passes a harmonic (a radio-frequency signal in the frequency band of the ultra-high band: see the arrow 41 in FIG. 1) of a middle-high band signal. However, the switch 133 shunts the harmonic (the radio-frequency signal in the frequency band of the ultra-high band) of the middle-high band signal having passed through the switch 131 to the reference potential.

As described above, the T-type switch 111 can shunt a harmonic (a radio-frequency signal in the frequency band of the ultra-high band) of a middle-high band signal to the reference potential and thus can provide isolation between the n77 front-end module 12 and/or the n79 front-end module 13 and the middle-high band front-end module 14.

### Second Operation in Comparative Example

A case is examined where the low band front-end module 11 (see FIG. 1), and the n77 front-end module 12 and/or the n79 front-end module 13 simultaneously operate. In this case, the power supply circuit 15 (see FIG. 1) supplies power to the low band front-end module 11 via the line 21, and the power supply circuit 16 (see FIG. 1) supplies power to the n77 front-end module 12 and/or the n79 front-end module 13 via the line 22.

In this case, the switch 131 and the switch 132 enter an ON state. Furthermore, the switch 133 enters an OFF state. Thus, power output from the power supply circuit 16 is supplied to an internal element of the n77 front-end module 12, and/or the n79 front-end module 13 via the line 22, the switch 131, and the switch 132.

At this time, the switch 121 and the switch 122 enter an OFF state. Furthermore, the switch 123 enters an ON state. Incidentally, when the switch 121 is in the OFF state, the switch 121 can interrupt the supply of power from the power supply circuit 15 but passes a harmonic (a radio-frequency signal in the frequency band of the ultra-high band: see the arrow 42 in FIG. 1) of a low band signal. However, the switch 123 shunts the harmonic (the radio-frequency signal in the frequency band of the ultra-high band) of the low band signal having passed through the switch 121 to the reference potential.

As described above, the T-type switch 110 can shunt a harmonic (a radio-frequency signal in the frequency band of the ultra-high band) of a low band signal to the reference potential and thus can provide isolation between the low band front-end module 11 and the n77 front-end module 12 and/or the n79 front-end module 13.

### Third Operation in Comparative Example

A case is examined where the low band front-end module 11 (see FIG. 1) and the middle-high band front-end module 14 (see FIG. 1) simultaneously operate. In this case, the power supply circuit 15 (see FIG. 1) supplies power to the low band front-end module 11 via the line 21, and the power supply circuit 16 (see FIG. 1) supplies power to the middle-high band front-end module 14 via the line 22.

In this case, the switch 121 and the switch 122 enter an OFF state. Furthermore, the switch 123 enters an ON state. Furthermore, the switch 131 and the switch 132 enter an OFF state. Furthermore, the switch 133 enters an ON state.

Incidentally, when the switch 121 is in the OFF state, the switch 121 can interrupt the supply of power from the power supply circuit 15 but passes a harmonic (a radio-frequency signal in the frequency band of the middle-high band: see the arrow 43 in FIG. 1) of a low band signal. However, the switch 123 shunts the harmonic (the radio-frequency signal in the frequency band of the middle-high band) of the low band signal having passed through the switch 121 to the reference potential.

As described above, the T-type switch 110 can shunt a harmonic (a radio-frequency signal in the frequency band of the middle-high band) of a low band signal to the reference potential and thus can provide isolation between the low band front-end module 11 and the middle-high band front-end module 14.

### Issues in Comparative Example

The T-type switch 110 includes three switches: the switches 121 to 123. The T-type switch 111 includes three switches: the switches 131 to 133. That is, the switch circuit 100 includes a total of six switches. Hence, the size and cost of the switch circuit 100 are large and high.

### First Embodiment

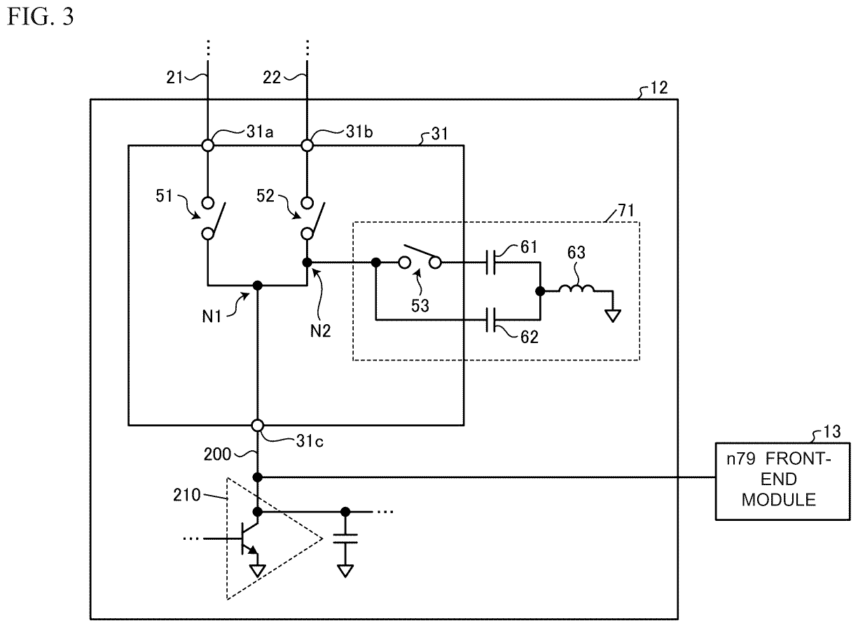

FIG. 3 is a diagram illustrating a configuration of the switch circuit according to the first embodiment.

The switch circuit 31 includes terminals 31a to 31c. The terminal 31a is electrically connected to the line 21 (see FIG. 1). The terminal 31b is electrically connected to the line 22 (see FIG. 1). The terminal 31c is electrically connected to an internal circuit (for example, the power amplifier 210) of the n77 front-end module 12, and the n79 front-end module 13 via the line 200.

The terminal 31a corresponds to an example of “first external connection terminal” in the present disclosure. The terminal 31b corresponds to an example of “second external connection terminal” in the present disclosure. The terminal 31c corresponds to an example of “third external connection terminal” in the present disclosure.

The switch circuit 31 includes switches 51 to 53.

The switch 51 corresponds to an example of “first switch” in the present disclosure. The switch 52 corresponds to an example of “second switch” in the present disclosure. The switch 53 corresponds to an example of “third switch” in the present disclosure.

The switch circuit 31 may be a single semiconductor device.

One end of the switch 51 is electrically connected to the terminal 31a. The other end of the switch 51 is electrically connected to a node N1. The node N1 is electrically connected to the terminal 31c.

The node N1 corresponds to an example of “first connection point” in the present disclosure.

One end of the switch 52 is electrically connected to the terminal 31b. The other end of the switch 52 is electrically connected to a node N2. The node N2 is electrically connected to the node N1.

The node N2 corresponds to an example of “second connection point” in the present disclosure.

One end of the switch 53 is electrically connected to the node N2. The other end of the switch 53 is electrically connected to one end of a capacitor 61 mounted in or on a substrate of the n77 front-end module 12.

One end of a capacitor 62 mounted in or on the substrate of the n77 front-end module 12 is electrically connected to the node N2.

The other end of the capacitor 61 and the other end of the capacitor 62 are electrically connected to one end of an inductor 63 mounted in or on the substrate of the n77 front-end module 12. The other end of the inductor 63 is electrically connected to the reference potential.

The capacitor 61 corresponds to an example of “first capacitor” in the present disclosure. The capacitor 62 corresponds to an example of “second capacitor” in the present disclosure. The inductor 63 corresponds to an example of “inductor” in the present disclosure.

The switch 53, the capacitor 61, the capacitor 62, and the inductor 63 constitute a filter 71.

The filter 71 reduces harmonics (see the arrows 41, 42, and 43 in FIG. 1) transmitted to the node N2.

When the switch 53 is in an OFF state, the filter 71 is a low pass filter in which the capacitor 62 and the inductor 63 are connected in series. When the switch 53 is in an ON state, the filter 71 is a low pass filter in which a parallel connection of the capacitor 61 and the capacitor 62 is connected in series with the inductor 63. That is, the filter 71 is a variable low pass filter whose pole varies according to ON and OFF states of the switch 53.

In the filter 71, when the switch 53 is in the OFF state, the electrostatic capacity of the capacitors is small in comparison with when the switch 53 is in the ON state. Hence, the pole of the filter 71 is located on a relatively high frequency side when the switch 53 is in the OFF state and is located on a relatively low frequency side when the switch 53 is in the ON state.

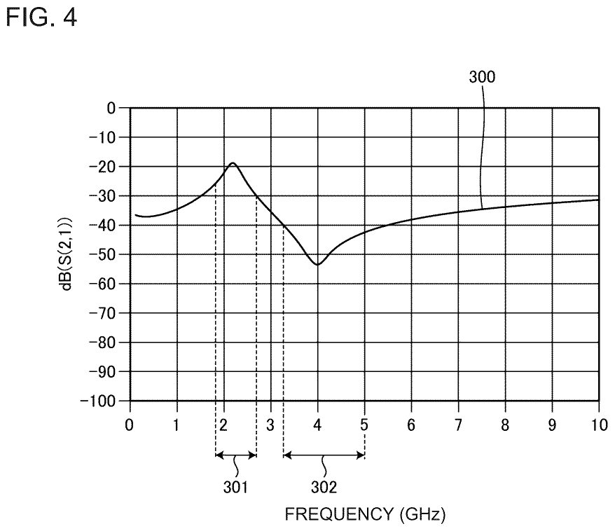

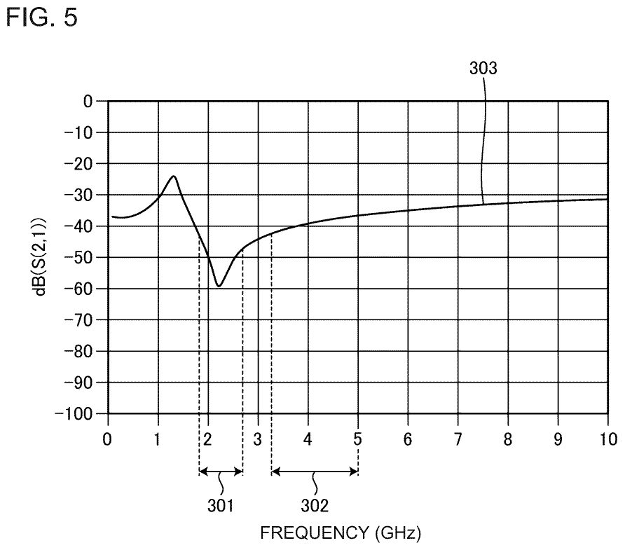

FIGS. 4 and 5 are graphs illustrating circuit simulation results of the switch circuit according to the first embodiment. Specifically, FIG. 4 is a graph illustrating circuit simulation results of the switch circuit 31 in which the switch 53 is in the OFF state. FIG. 5 is a graph illustrating circuit simulation results of the switch circuit 31 in which the switch 53 is in the ON state.

In FIGS. 4 and 5, a frequency band 301 is the frequency band (for example, 1.805 GHZ to 2.690 GHZ) of the middle-high band. A frequency band 302 is the frequency band (for example, n77 (3.300 GHz) to n79 (5.000 GHz)) of the ultra-high band.

Referring to FIG. 4, as indicated by a line 300, the switch circuit 31 can reduce radio-frequency signals in the frequency band 302 when the switch 53 is in the OFF state.

Referring to FIG. 5, as indicated by a line 303, the switch circuit 31 can reduce radio-frequency signals in the frequency band 301 when the switch 53 is in the ON state.

Referring back to FIG. 3, the operation of the switch circuit 31 will be described.

### First Operation in First Embodiment

A case is examined where the n77 front-end module 12 and/or the n79 front-end module 13, and the middle-high band front-end module 14 (see FIG. 1) simultaneously operate. In this case, the power supply circuit 15 (see FIG. 1) supplies power to the n77 front-end module 12 and/or the n79 front-end module 13 via the line 21, and the power supply circuit 16 (see FIG. 1) supplies power to the middle-high band front-end module 14 via the line 22.

In this case, the switch 51 enters an ON state. Furthermore, the switch 52 enters an OFF state. Furthermore, the switch 53 enters an OFF state. Thus, power output from the power supply circuit 15 is supplied to an internal element of the n77 front-end module 12, and/or the n79 front-end module 13 via the line 21 and the switch 51.

Incidentally, when the switch 52 is in the OFF state, the switch 52 can interrupt the supply of power from the power supply circuit 16 but passes a harmonic (a radio-frequency signal in the frequency band of the ultra-high band: see the arrow 41 in FIG. 1) of a middle-high band signal.

However, since the switch 53 is in the OFF state, the filter 71 reduces harmonics (radio-frequency signals in the frequency band of the ultra-high band) of the middle-high band signal as illustrated in FIG. 4.

As described above, the switch circuit 31 can reduce harmonics (radio-frequency signals in the frequency band of the ultra-high band) of a middle-high band signal and thus can provide isolation between the n77 front-end module 12 and/or the n79 front-end module 13 and the middle-high band front-end module 14.

### Second Operation in First Embodiment

A case is examined where the low band front-end module 11 (see FIG. 1), and the n77 front-end module 12 and/or the n79 front-end module 13 simultaneously operate. In this case, the power supply circuit 15 (see FIG. 1) supplies power to the low band front-end module 11 via the line 21, and the power supply circuit 16 (see FIG. 1) supplies power to the n77 front-end module 12 and/or the n79 front-end module 13 via the line 22.

In this case, the switch 51 enters an OFF state. Furthermore, the switch 52 enters an ON state. Furthermore, the switch 53 enters an OFF state. Thus, power output from the power supply circuit 16 is supplied to an internal element of the n77 front-end module 12, and/or the n79 front-end module 13 via the line 22 and the switch 52.

Incidentally, when the switch 51 is in the OFF state, the switch 51 can interrupt the supply of power from the power supply circuit 15 but may pass a harmonic (a radio-frequency signal in the frequency band of the ultra-high band: see the arrow 42 in FIG. 1) of a low band signal.

However, since the switch 53 is in the OFF state, the filter 71 reduces harmonics (radio-frequency signals in the frequency band of the ultra-high band) of the low band signal as illustrated in FIG. 4.

As described above, the switch circuit 31 can reduce harmonics (radio-frequency signals in the frequency band of the ultra-high band) of a low band signal and thus can provide isolation between the low band front-end module 11 and the n77 front-end module 12 and/or the n79 front-end module 13.

### Third Operation in First Embodiment

A case is examined where the low band front-end module 11 (see FIG. 1) and the middle-high band front-end module 14 (see FIG. 1) simultaneously operate. In this case, the power supply circuit 15 (see FIG. 1) supplies power to the low band front-end module 11 via the line 21, and the power supply circuit 16 (see FIG. 1) supplies power to the middle-high band front-end module 14 via the line 22.

In this case, the switch 51 enters an OFF state.

Furthermore, the switch 52 enters an OFF state.
Furthermore, the switch 53 enters an ON state.

Incidentally, when the switch 51 is in the OFF state, the switch 51 can interrupt the supply of power from the power supply circuit 15 but passes a harmonic (a radio-frequency signal in the frequency band of the middle-high band: see the arrow 43 in FIG. 1) of a low band signal.

However, since the switch 53 is in the ON state, the filter 71 reduces harmonics (radio-frequency signals in the frequency band of the middle-high band) of the low band signal as illustrated in FIG. 5.

As described above, the switch circuit 31 can reduce harmonics (radio-frequency signals in the frequency band of the middle-high band) of a low band signal and thus can provide isolation between the low band front-end module 11 and the middle-high band front-end module 14.

### Effects

In the switch circuit 100 according to the comparative example, although a harmonic transmitted through the line 21 is shunted to the reference potential by the switch 123, the switch 121 and the switch 122 have to be provided to interrupt power supply voltages (direct-current voltages) supplied from the power supply circuit 15 and the power supply circuit 16. Similarly, in the switch circuit 100, although a harmonic transmitted through the line 22 is shunted to the reference potential by the switch 133, the switch 131 and the switch 132 have to be provided to interrupt power supply voltages (direct-current voltages) supplied from the power supply circuit 15 and the power supply circuit 16. Hence, the switch circuit 100 have to include six switches: the switches 121 to 123 and the switches 131 to 133.

On the other hand, in the switch circuit 31 according to the first embodiment, harmonics transmitted through the line 21 and the line 22 are reduced by the filter 71. Furthermore, the filter 71 includes the capacitor 61 and the capacitor 62. The capacitor 61 and the capacitor 62 can interrupt power supply voltages (direct-current voltages) supplied from the power supply circuit 15 and the power supply circuit 16. Hence, the switch circuit 31 does not have to include any switch for interrupting power supply voltages (direct-current voltages) supplied from the power supply circuit 15 and the power supply circuit 16.

Furthermore, when the switch 53 is put into an ON state or an OFF state, the filter 71 can switch between reduction of radio-frequency signals in the frequency band of the ultra-high band and reduction of radio-frequency signals in the frequency band of the middle-high band. In the filter 71, another control line or control method is optional for switching.

Thus, the switch circuit 31 can be implemented by using three switches: the switches 51 to 53.

As described above, in the switch circuit 31, the number of switches can be reduced from six to three in comparison with the switch circuit 100, and thus the size and cost of the switch circuit 31 can be reduced.

Consequently, the size and cost of the n77 front-end module 12 can be reduced.

### Second Embodiment

### Configuration

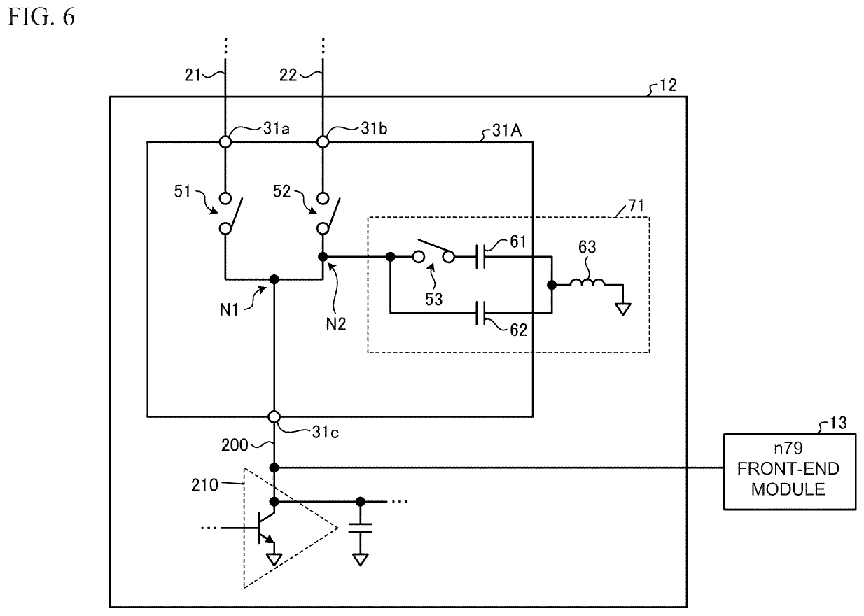

FIG. 6 is a diagram illustrating a configuration of a switch circuit according to a second embodiment.

In comparison with the switch circuit 31 according to the first embodiment (see FIG. 3), a switch circuit 31A according to the second embodiment further includes the capacitor 61 and the capacitor 62. That is, the switches 51 to 53, the capacitor 61, and the capacitor 62 may be included in the single semiconductor device.

### Effects

In the switch circuit 31A, the number of components can be reduced in comparison with the switch circuit 31. Thus, the size and cost of the n77 front-end module 12 can be further reduced.

### Third Embodiment

### Configuration

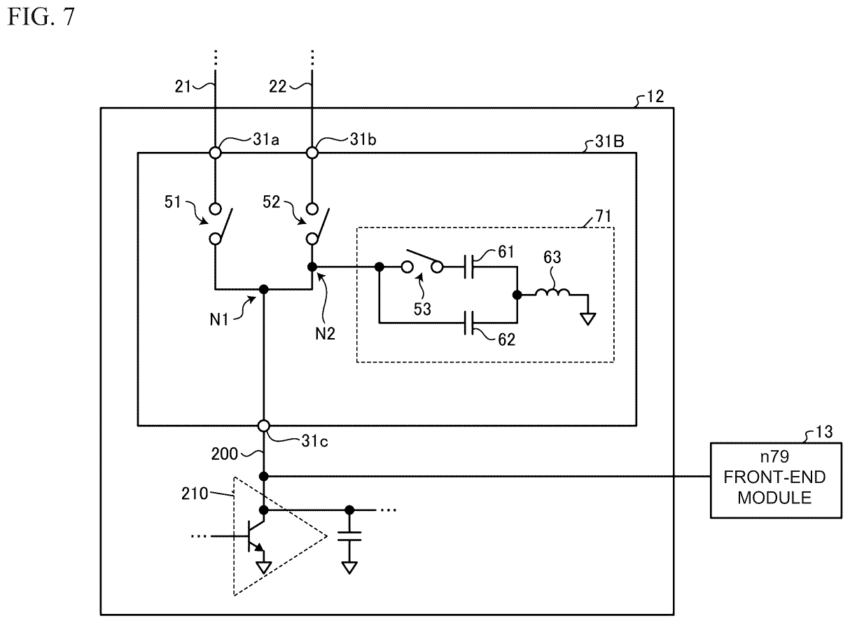

FIG. 7 is a diagram illustrating a configuration of a switch circuit according to a third embodiment.

In comparison with the switch circuit 31A according to the second embodiment (see FIG. 6), a switch circuit 31B according to the third embodiment further includes the inductor 63. That is, the switches 51 to 53, the capacitor 61, the capacitor 62, and the inductor 63 may be included in the single semiconductor device.

### Effects

In the switch circuit 31B, the number of components can be further reduced in comparison with the switch circuit 31A. Thus, the size and cost of the n77 front-end module 12 can be further reduced.

### Fourth Embodiment

### Configuration

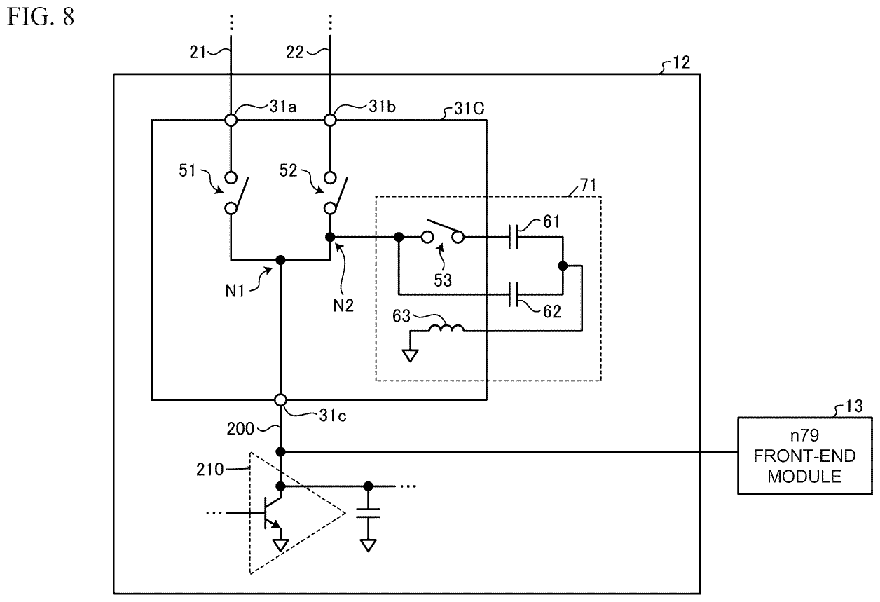

FIG. 8 is a diagram illustrating a configuration of a switch circuit according to a fourth embodiment.

In comparison with the switch circuit 31 according to the first embodiment (see FIG. 3), a switch circuit 31C according to the fourth embodiment further includes the inductor 63. That is, the switches 51 to 53 and the inductor 63 may be included in the single semiconductor device.

### Effects

In the switch circuit 31C, the number of components can be reduced in comparison with the switch circuit 31. Thus, the size and cost of the n77 front-end module 12 can be further reduced.

### Configuration Examples of Present Disclosure

The present disclosure can also take the following configurations.
(1)

A radio-frequency module comprising:
a first external connection terminal electrically connected to a first external power supply;
a second external connection terminal electrically connected to a second external power supply;
a first switch having one end electrically connected to the first external connection terminal and another end electrically connected to a first connection point;
a second switch having one end electrically connected to the second external connection terminal and another end electrically connected to the first connection point;
a third external connection terminal electrically connected to the first connection point; and
a third switch having one end electrically connected to a second connection point between the other end of the second switch and the third external connection terminal,
wherein another end of the third switch is electrically connected to one end of a first capacitor,
wherein the second connection point is electrically connected to one end of a second capacitor,
wherein another end of the first capacitor and another end of the second capacitor are electrically connected to one end of an inductor, and
wherein another end of the inductor is electrically connected to a reference potential.
(2)

The radio-frequency module according to the above (1),
wherein the first switch, the second switch, the third switch, the first capacitor, the second capacitor, and the inductor are included in a single semiconductor device.
(3)

The radio-frequency module according to the above (1),
wherein the first switch, the second switch, the third switch, the first capacitor, and the second capacitor are included in a single semiconductor device.
(4)

The radio-frequency module according to the above (1),
wherein the first switch, the second switch, the third switch, and the inductor are included in a single semiconductor device.
(5)

The radio-frequency module according to any one of the above (1) to (4),
wherein, when the first switch is in an ON state, the third switch is in an OFF state,
wherein, when the second switch is in an ON state, the third switch is in an OFF state, and
wherein, when the first switch and the second switch are in an OFF state, the third switch is in an ON state.

The above-described embodiments are intended to facilitate understanding of the present disclosure but are not intended for a limited interpretation of the present disclosure. The present disclosure can be changed or improved without necessarily departing from the gist thereof and also encompasses equivalents thereof.

What is claimed is:

1. A radio-frequency module comprising:
a first external connection terminal electrically connected to a first external power supply;
a second external connection terminal electrically connected to a second external power supply;
a first switch having a first end electrically connected to the first external connection terminal, and a second end electrically connected to a first connection point;
a second switch having a first end electrically connected to the second external connection terminal, and a second end electrically connected to the first connection point;
a third external connection terminal electrically connected to the first connection point; and
a third switch having a first end electrically connected to a second connection point, the second connection point being between the second end of the second switch and the third external connection terminal,
wherein a second end of the third switch is electrically connected to a first end of a first capacitor,
wherein the second connection point is electrically connected to a first end of a second capacitor,
wherein a second end of the first capacitor and a second end of the second capacitor are electrically connected to a first end of an inductor, and
wherein a second end of the inductor is electrically connected to a reference potential.

2. The radio-frequency module according to claim 1, wherein the first switch, the second switch, the third switch, the first capacitor, the second capacitor, and the inductor are in a single semiconductor device.

3. The radio-frequency module according to claim 1, wherein the first switch, the second switch, the third switch, the first capacitor, and the second capacitor are in a single semiconductor device.

4. The radio-frequency module according to claim 1, wherein the first switch, the second switch, the third switch, and the inductor are in a single semiconductor device.

5. The radio-frequency module according to claim 1,
wherein, when the first switch is in an ON state, the third switch is in an OFF state,
wherein, when the second switch is in an ON state, the third switch is in an OFF state, and
wherein, when the first switch and the second switch are in an OFF state, the third switch is in an ON state.

6. The radio-frequency module according to claim 2,
wherein, when the first switch is in an ON state, the third switch is in an OFF state,
wherein, when the second switch is in an ON state, the third switch is in an OFF state, and
wherein, when the first switch and the second switch are in an OFF state, the third switch is in an ON state.

7. The radio-frequency module according to claim 3,
wherein, when the first switch is in an ON state, the third switch is in an OFF state,
wherein, when the second switch is in an ON state, the third switch is in an OFF state, and
wherein, when the first switch and the second switch are in an OFF state, the third switch is in an ON state.

8. The radio-frequency module according to claim 4,
wherein, when the first switch is in an ON state, the third switch is in an OFF state,
wherein, when the second switch is in an ON state, the third switch is in an OFF state, and
wherein, when the first switch and the second switch are in an OFF state, the third switch is in an ON state.
